(19) United States
(12) Patent Application Publication
(10) Pub. No.: US 2026/0331938 A1
(43) Pub. Date: Oct. 22, 2026

(54) RECHARGEABLE ENERGY STORAGE SYSTEM FOR A VEHICLE

(71) Applicant: GM Global Technology Operations LLC, Detroit, MI (US)

(72) Inventors: Chandra S. Namuduri, Troy, MI (US); Orgun A. Guralp, Northville, MI (US); Madhusudan Raghavan, West Bloomfield, MI (US)

(73) Assignee: GM Global Technology Operations LLC, Detroit, MI (US)

(21) Appl. No.: 19/180,690

(22) Filed: Apr. 16, 2025

(51) Int. Cl. H02J 7/00; B60L 53/65; B60L 58/20

(52) U.S. Cl. CPC H02J 7/92; B60L 53/65; B60L 58/20; H02J 7/933

(57) ABSTRACT

A rechargeable energy storage system for a vehicle includes a plurality of voltage subpacks, a series of switches operably coupled to the plurality of voltage subpacks, and a controller. The controller includes data processing hardware and memory hardware in communication with the data processing hardware. The memory hardware stores instructions that when executed on the data processing hardware cause the data processing hardware to perform operations including executing, in response to charging data received by the controller, an energy storage architecture, identifying, via the energy storage architecture, a charging system category based on the charging data, the charging system category including one of a mega watt charging system and a combined charging system, executing, via the energy storage architecture, switch sequencing at one or more of the series of switches, and activating, based on the executed switch sequencing, at least one voltage subpack of the plurality of voltage subpacks.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a rechargeable energy storage system for a vehicle.

Electric vehicles (EVs) are becoming more popular as an alternative to conventional vehicles that use fossil fuels. EVs offer various advantages, such as reduced emissions, lower operating costs, and improved performance. However, one of the main challenges facing EVs is the limited range and long charging time compared to conventional vehicles. EVs typically rely on batteries to store electrical energy that can be converted to mechanical energy to drive the vehicle. The batteries have a finite capacity and need to be recharged periodically from an external power source, such as a charging station.

Charging stations are devices that provide electrical energy to the batteries of EVs through a cable and a connector. The charging time and the amount of energy transferred depend on various factors, such as the battery capacity, the battery state of charge, the charging power, and the charging voltage. Generally, higher charging power and higher charging voltage can reduce the charging time and increase the energy transferred, but they also pose technical challenges.

Most of the existing charging stations use a charging voltage of less than 1000 volts and a maximum charging power of up to around 350 kilowatts. These values are sufficient for most of the current EVs, which have relatively small batteries and moderate range requirements. However, for future EVs, these values may not be enough to meet the customer expectations and the market demands. Future EVs may have larger batteries and higher range requirements and may need to be able to charge quickly and conveniently, similar to filling a gas tank. To achieve this, a much higher charging power and a much higher charging voltage may be needed.

However, increasing the charging power and the charging voltage also increases the challenges and the risks associated with the charging system. For example, once the charging power exceeds 350 kilowatts, it becomes more difficult to maintain the same charging voltage, as the current required to deliver that power becomes very high. The cables and the connectors that carry the current need to be larger and heavier, which makes them less flexible and more difficult to handle by the users. Moreover, the high current and the high voltage may generate more heat and more electromagnetic interference, which may affect the performance of the charging system and the EV. Therefore, there is a need for an improved energy system for a vehicle that can provide high-voltage, high-power charging without compromising the usability and the reliability of the system.

### SUMMARY

In some aspects, a rechargeable energy storage system for a vehicle includes a plurality of voltage subpacks, a series of switches operably coupled to the plurality of voltage subpacks, and a controller. The controller includes data processing hardware and memory hardware in communication with the data processing hardware. The memory hardware stores instructions that when executed on the data processing hardware cause the data processing hardware to perform operations. The operations include executing, in response to charging data received by the controller, an energy storage architecture, identifying, via the energy storage architecture, a charging system category based on the charging data, the charging system category including one of a mega watt charging system and a combined charging system, executing, via the energy storage architecture, switch sequencing at one or more of the series of switches, and activating, based on the executed switch sequencing, at least one voltage subpack of the plurality of voltage subpacks.

In some examples, the plurality of voltage subpacks may include at least three voltage subpacks and the series of switches may include a first switch series, a second switch series, and a third switch series. The third switch series may be disposed between and operably coupled to the plurality of voltage subpacks. Optionally, the at least three voltage subpacks may include a first voltage subpack, a second voltage subpack, and a third voltage subpack, the second voltage subpack and the third voltage subpack may have a voltage that is less than a voltage of the first voltage subpack. In some configurations, executing the switch sequencing may include opening one switch of the first switch series, one switch of the second switch series, and one switch of the third switch series and closing a remainder of switches of the series of switches. In other examples, executing the switch sequencing may include opening two switches of the first switch series, one switch of the second switch series, and one switch of the third switch series and closing a remainder of switches of the series of switches.

In further examples, executing the switch sequencing may include opening one switch of the first switch series, two switches of the second switch series, and two switches of the third switch series and closing a remainder of switches of the series of switches. Optionally, executing the switch sequencing may include opening two switches of the first switch series and two switches of the second switch series, closing all of the third switch series and closing a remainder of switches of the first switch series and a remainder of switches of the second switch series. In other instances, executing the switch sequencing may include opening three switches of the third switch series and closing a remainder of switches of each of the first switch series and the second switch series. In some examples, executing the switch sequencing may include opening at least two switches of the first switch series, at least two switches of the second switch series, and one switch of the third switch series and closing a remainder of switches of the series of switches. Optionally, executing the switch sequencing may include opening three switches of the first switch series and three switches of the second switch series, closing all of the third switch series and closing a remainder of switches of the first switch series and a remainder of switches of the second switch series.

In other aspects, a rechargeable energy storage system for a vehicle includes a plurality of voltage subpacks including at least three voltage subpacks, a series of switches operably coupled to the plurality of voltage subpacks, the series of switches includes a first switch series, a second switch series, and a third switch series, the third switch series disposed between and operably coupled to the plurality of voltage subpacks, and a controller. The controller includes data processing hardware and memory hardware in communication with the data processing hardware. The memory hardware stores instructions that when executed on the data processing hardware cause the data processing hardware to perform operations. The operations include executing, in response to charging data received by the controller, an energy storage architecture, identifying, via the energy storage architecture, a charging system category based on the charging data, the charging system category including one of a mega watt charging system and a combined charging system, executing, via the energy storage architecture, switch sequencing at one or more of the series of switches, the switch sequencing including opening at least three switches from at least one of the first switch series, the second switch series, and the third switch series and closing a remainder of switches of the series of switches, and activating, based on the executed switch sequencing, at least one voltage subpack of the plurality of voltage subpacks.

In some examples, executing the switch sequencing may include opening one switch of the first switch series, one switch of the second switch series, and one switch of the third switch series and closing a remainder of switches of the series of switches. Optionally, executing the switch sequencing may include opening two switches of the first switch series, one switch of the second switch series, and one switch of the third switch series and closing a remainder of switches of the series of switches. In some instances, executing the switch sequencing may include opening one switch of the first switch series, two switches of the second switch series, and two switches of the third switch series and closing a remainder of switches of the series of switches. In other instances, executing the switch sequencing may include opening two switches of the first switch series and two switches of the second switch series, closing all of the third switch series and closing a remainder of switches of the first switch series and a remainder of switches of the second switch series.

In further examples, executing the switch sequencing may include opening three switches of the third switch series and closing a remainder of switches of each of the first switch series and the second switch series. In other configurations, executing the switch sequencing may include opening two switches of the first switch series, two switches of the second switch series, and one switch of the third switch series and closing a remainder of switches of the series of switches. Optionally, executing the switch sequencing may include opening three switches of the first switch series, two switches of the second switch series, and one switch of the third switch series and closing a remainder of switches of the series of switches. In further instances, executing the switch sequencing may include opening two switches of the first switch series, three switches of the second switch series, and one switch of the third switch series and closing a remainder of switches of the series of switches. In other configurations, executing the switch sequencing may include opening three switches of the first switch series and three switches of the second switch series, closing all of the third switch series and closing a remainder of switches of the first switch series and a remainder of switches of the second switch series.

### BRIEF DESCRIPTION OF THE DRAWINGS

The drawings described herein are for illustrative purposes only of selected configurations and are not intended to limit the scope of the present disclosure.

FIG. 1 is a diagram of a vehicle connected to a charging station, the vehicle equipped with a rechargeable energy storage system according to the present disclosure;

FIG. 2 is an exemplary block diagram of a rechargeable energy storage system according to the present disclosure;

FIG. 3 is an exemplary block diagram of a rechargeable energy storage system according to the present disclosure;

FIG. 4 is a schematic diagram of the rechargeable energy storage system of FIG. 3, the rechargeable energy storage system including a first series of switches, a second series of switches, and a third series of switches in various states of open and closed;

FIG. 5 is a schematic diagram of the rechargeable energy storage system of FIG. 3, the rechargeable energy storage system including a first series of switches, a second series of switches, and a third series of switches in various states of open and closed;

FIG. 6 is another schematic diagram of the rechargeable energy storage system of FIG. 3, the rechargeable energy storage system including a first series of switches, a second series of switches, and a third series of switches in various states of open and closed;

FIG. 7 is yet another schematic diagram of the rechargeable energy storage system of FIG. 3, the rechargeable energy storage system including a first series of switches, a second series of switches, and a third series of switches in various states of open and closed;

FIG. 8 is another exemplary block diagram of a rechargeable energy storage system according to the present disclosure;

FIG. 9 is a schematic diagram of the rechargeable energy storage system of FIG. 8, the rechargeable energy storage system including a first series of switches, a second series of switches, and a third series of switches in various states of open and closed;

FIG. 10 is another schematic diagram of the rechargeable energy storage system of FIG. 8, the rechargeable energy storage system including a first series of switches, a second series of switches, and a third series of switches in various states of open and closed;

FIG. 11 is still another schematic diagram of the rechargeable energy storage system of FIG. 8, the rechargeable energy storage system including a first series of switches, a second series of switches, and a third series of switches in various states of open and closed;

FIG. 12 is a further schematic diagram of the rechargeable energy storage system of FIG. 8, the rechargeable energy storage system including a first series of switches, a second series of switches, and a third series of switches in various states of open and closed;

FIG. 13 is another schematic diagram of the rechargeable energy storage system of FIG. 8, the rechargeable energy storage system including a first series of switches, a second series of switches, and a third series of switches in various states of open and closed;

FIG. 14 is an exemplary flow diagram of operation of a rechargeable energy storage system according to the present disclosure; and

FIG. 15 is an exemplary method of operation of a rechargeable energy storage system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

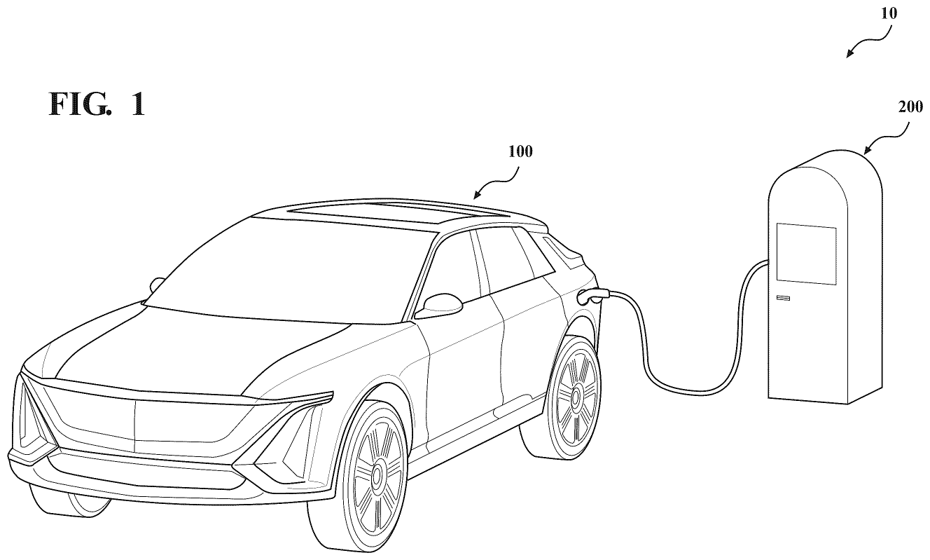

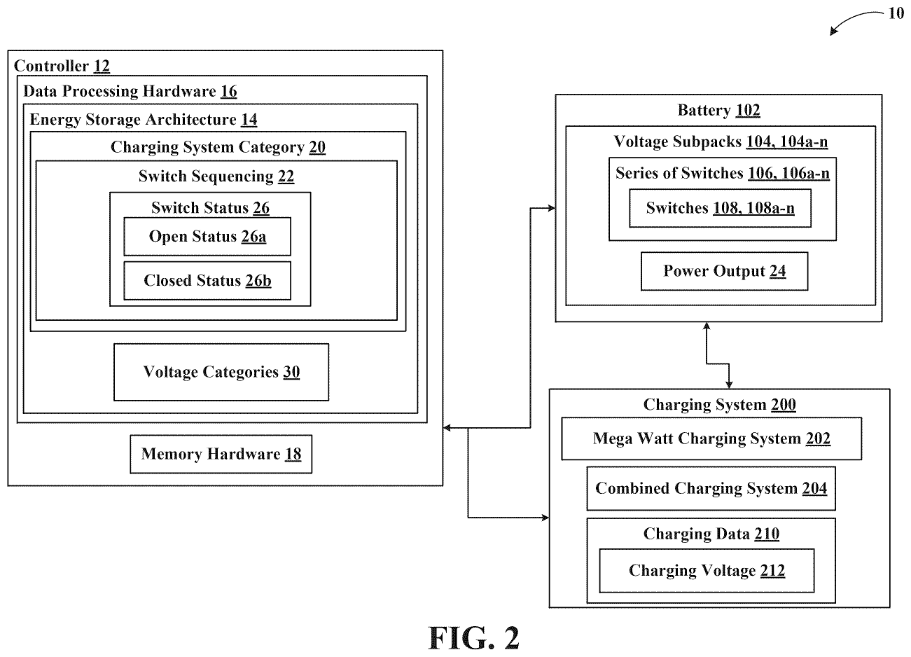

Referring to FIGS. 1 and 2, a vehicle 100 is equipped with a rechargeable energy storage system 10. For example, the vehicle 100 may be an electric vehicle (EV) and/or a hybrid electric vehicle (HEV) that utilizes a battery 102 to at least partially power the vehicle 100. The battery 102 is configured to be selectively charged using a third-party charging system 200. The charging system 200 may be configured as one of a mega watt charging system 202 and a combined charging system 204. The charging system 200 may thus be configured to provide varying degrees of power to the battery 102 of the vehicle 100 depending on the configuration of the charging system 200 (i.e., whether the charging system 200 is a mega watt charging system 202 or a combined charging system 204).

The battery 102 of the vehicle 100 includes a plurality of voltage subpacks 104 and a series of switches 106 that are operably coupled to the voltage subpacks 104. The voltage subpacks 104 may range in number depending on the configuration of the battery 102, and the number of switches of the series of switches 106 may similarly range to reflect an increased or decreased number of voltage subpacks 104. The voltage subpacks 104 include at least three voltage subpacks 104, 104a-n, and the series of switches 106 include at least three series of switches 106, 106a-n. The series of switches 106, 106a-n includes a first switch series 106a, a second switch series 106b, and a third switch series 106c of the series of switches 106. Each of the series of switches 106, 106a-n includes switches 108. For example, the first switch series 106a includes switches 108, 108a₁₋ₙ, the second switch series 106b includes switches 108, 108b₁₋ₙ, and the third switch series 106c includes switches 108, 108c₁₋ₙ. The number of switches 108 of the series of switches 106 may vary depending on the configuration of the battery 102, as described in more detail below.

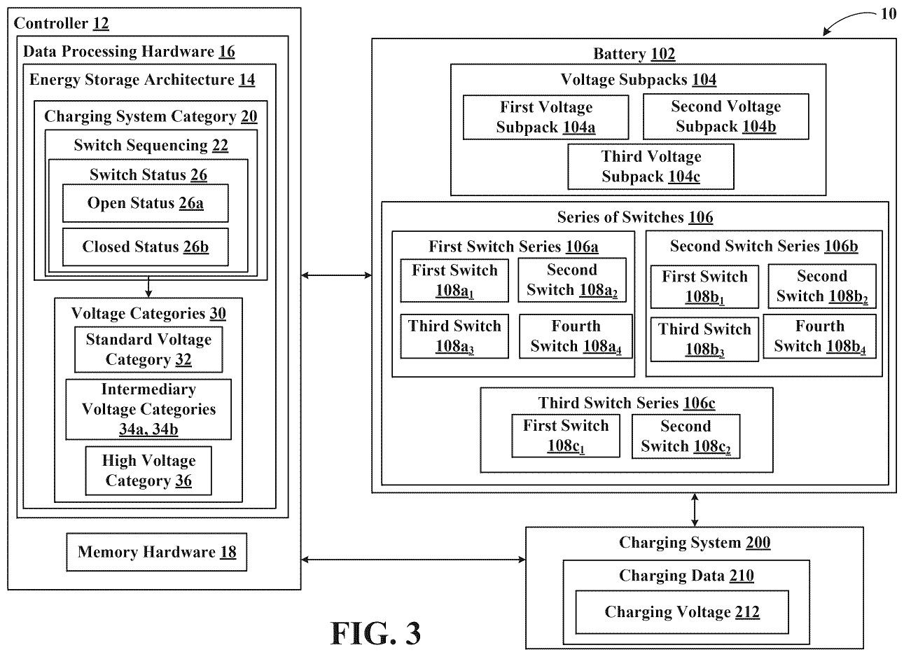

For example, FIGS. 3-6 illustrate that the first switch series 106a includes a first switch 108a₁, a second switch 108a₂, a third switch 108a₃, and a fourth switch 108a₄. The second switch series 106b includes a first switch 108b₁, a second switch 108b₂, a third switch 108b₃, and a fourth switch 108b₄. The third switch series 106c includes 108c₁ and a second switch 108c₂. The battery 102 of the rechargeable energy storage system 10 is also illustrated as being configured with a first voltage subpack 104a, a second voltage subpack 104b, and a third voltage subpack 104c each being operably coupled to at least one of the series of switches 106.

In this configuration, the first voltage subpack 104a has a voltage that is greater than a voltage of both the second voltage subpack 104b and the third voltage subpack 104c. For example, the second voltage subpack 104b and the third voltage subpack 104c may each have a voltage of approximately half of the voltage of the voltage of the first voltage subpack 104a. Thus, the second voltage subpack 104b and the third voltage subpack 104c each have a voltage that is less than the voltage of the first voltage subpack 104a. For example, the first voltage subpack 104a may have a voltage of approximately 700 volts (V) to approximately 750 V, and the second voltage subpack 104b and the third voltage subpack 104c may each have a voltage of approximately 350 V.

The battery 102 is communicatively coupled with a controller 12 of the rechargeable energy storage system 10, such that the controller 12 is configured to at least partially control the operation of the battery 102. For example, the controller 12 includes an energy storage architecture 14 that is configured to selectively activate the voltage subpacks 104 via opening and closing of switches of the series of switches 106. The controller 12 includes data processing hardware 16 that is configured to execute the energy storage architecture 14 and includes memory hardware 18 in communication with the data processing hardware 16. The memory hardware 18 stores instructions that, when executed by the data processing hardware 16, cause the data processing hardware 16 to perform operations, described herein, including executing the energy storage architecture 14.

The energy storage architecture 14 may receive charging data 210 associated with the charging system 200 when the vehicle 100 is electrically coupled with the charging system 200. The energy storage architecture 14 is configured to identify a charging system category 20 based on the charge data 210. For example, the charge data 210 may indicate whether the charging system 200 is a mega watt charging system 202 or a combined charging system 204. The energy storage architecture 14 utilizes the identified charging system category 20 to determine a switch sequencing 22 execution. The switch sequencing 22 is configured to activate or otherwise execute one or more of the series of switches 106. The switch sequencing 22 results in the energy storage architecture 14 selectively activating at least two of the voltage subpacks 104, 104a-n to deliver a power output 24 compatible with the charging system 200 based on the charging system category 20.

The voltage subpacks 104, 104a-n are selectively activated by opening and closing the switches 108 of the series of switches 106. The energy storage architecture 14 is configured to determine the switch sequencing 22 based on the charging system category 20. For example, the switch sequencing 22 may include voltage categories 30 that are defined by a switch status 26 of each switch 108, 108a₁₋ₙ-108c₁₋ₙ. The switch status 26 may be a binary status, such that the respective switch 108 has either an open status 26a or a closed status 26b. The voltage categories 30 of the switch sequencing 22 correspond to a charging voltage 212 of the charging system 200 based on the identified charging system category 20.

For example, the voltage categories 30 may include a standard voltage category 32, one or more intermediary voltage categories 34a, 34b, and a high voltage category 36. The one or more intermediary voltage categories 34a, 34b may include a first intermediary voltage category 34a and a second intermediary voltage category 34b, described in more detail below. By way of example, not limitation, the standard voltage category 32 may include a charging voltage 212 of approximately 700 V. The one or more intermediary voltage categories 34a, 34b may include a charging voltage 212 of approximately 1050 V. The high voltage category 36 may include a charging voltage 212 of approximately 1400 V.

In the standard voltage category 32, one of the switches 108a₁-108a₄ of the first switch series 106a has the open status 26a, one of the switches 108b₁-108b₄ of the second switch series 106b has the open status 26a, and one of the switches 108c₁-108c₂ has the open status 26a. For example, FIG. 3 illustrates the fourth switch 108a₄ of the first switch series 106a being in the open status 26a, while the remainder of switches 108a₁-108a₃ of the first switch series 106a are in the closed status 26b. The second switch series 106b is illustrated with the third switch 108b₃ being in the open status 26a, while the remainder of switches 108a₁, 108a₂, 108a₄ are in the closed status 26b. The third switch series 106c is illustrated with the first switch 108c₁ in the open status 26a and the second switch 108c₂ in the closed status 26b. As a result, the second voltage subpack 104b and the third voltage subpack 104c are activated, while the first voltage subpack 104a remains inactive in the standard voltage category 32.

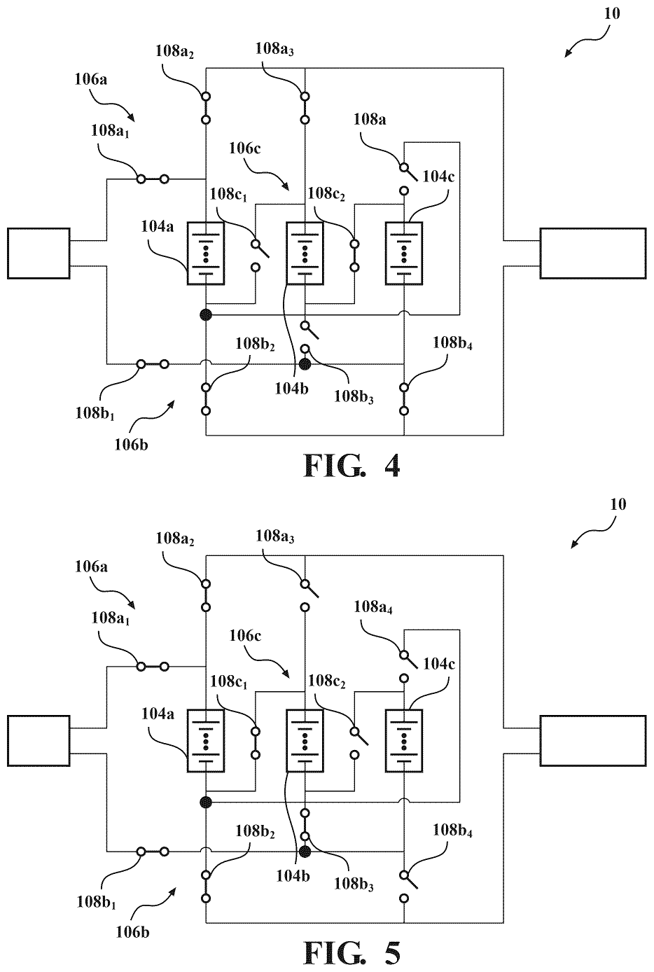

The intermediary voltage categories 34a, 34b are illustrated in FIGS. 4 and 5. The first intermediary voltage category 34a, illustrated in FIG. 4, includes two of the switches 108a₁-108a₄ of the first switch series 106a having the open status 26a, one of the switches 108b₁-108b₄ of the second switch series 106b having the open status 26a, and one of the switches 108c₁-108c₂ having the open status 26a. For example, the third switch 108a₃ and the fourth switch 108a₄ of the first switch series 106a are illustrated in the open status 26a, while the remainder of switches 108a₁-108a₂ of the first switch series 106a are in the closed status 26b. The second switch series 106b is illustrated with the fourth switch 108b₄ being in the open status 26a, while the remainder of switches 108b₁-108b₃ are in the closed status 26b. The third switch series 106c is illustrated with the second switch 108c2 in the open status 26a and the first switch 108c₁ in the closed status 26b. As a result, the first voltage subpack 104a and the second voltage subpack 104b are activated, while the third voltage subpack 104c remains inactive in the first intermediary voltage category 34a.

In the second intermediary voltage category 34b, illustrated in FIG. 5, one of the switches 108a₁-108a₄ of the first switch series 106a has the open status 26a, two of the switches 108b₁-108b₄ of the second switch series 106b have the open status 26a, and two of the switches 108c₁-108c₂ of the third switch series 106c have the open status 26a. For example, the third switch 108a₃ of the first switch series 106a is illustrated in the open status 26a, while the remainder of switches 108a₁-108a₂, 108a₄ of the first switch series 106a are in the closed status 26b. The second switch series 106b is illustrated with the fourth switch 108b₄ being in the open status 26a, while the remainder of switches 108b₁-108b₃ are in the closed status 26b. The third switch series 106c is illustrated with both the first switch 108c₁ and the second switch 108c₂ in the open status 26a. As a result, the first voltage subpack 104a and the third voltage subpack 104c are activated, while the second voltage subpack 104b remains inactive in the second intermediary voltage category 34b.

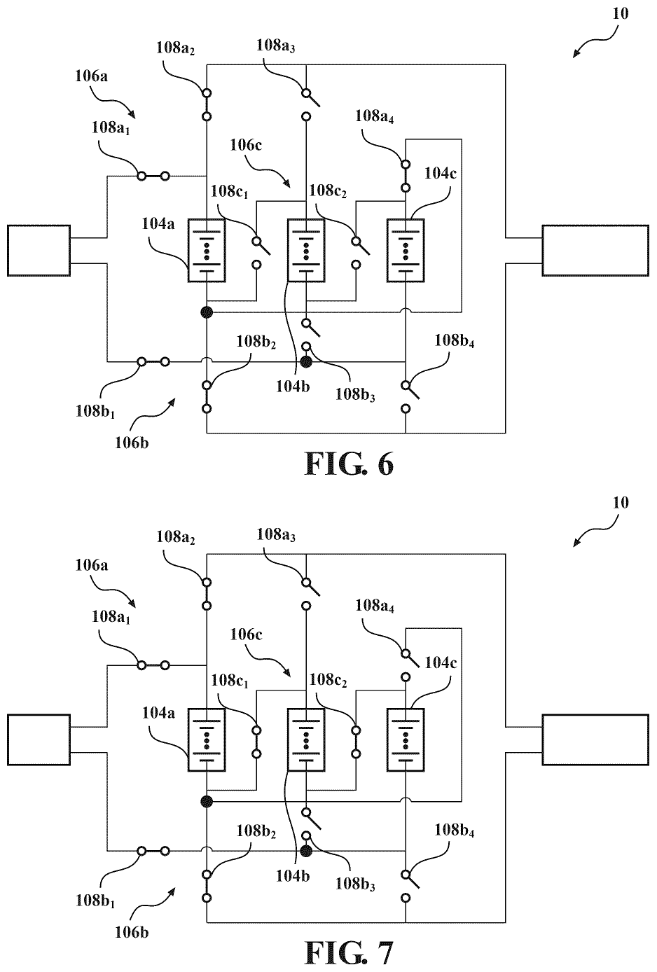

In the high voltage category 36, illustrated in FIG. 6, two of the switches 108a₁-108a₄ of the first switch series 106a have the open status 26a, one of the switches 108b₁-108b₄ of the second switch series 106b has the open status 26a, and one of the switches 108c₁-108c₂ has the open status 26a. For example, the third switch 108a₃ and the fourth switch 108a₄ of the first switch series 106a are illustrated in the open status 26a, while the remainder of switches 108a₁, 108a₂ of the first switch series 106a are in the closed status 26b. The second switch series 106b is illustrated with the fourth switch 108b₄ being in the open status 26a, while the remainder of switches 108b₁-108b₃ are in the closed status 26b. The third switch series 106c is illustrated with both the first switch 108c₁ and the second switch 108c₂ in the closed status 26b. As a result, all three voltage subpacks 104a-104c are activated in the high voltage category 36.

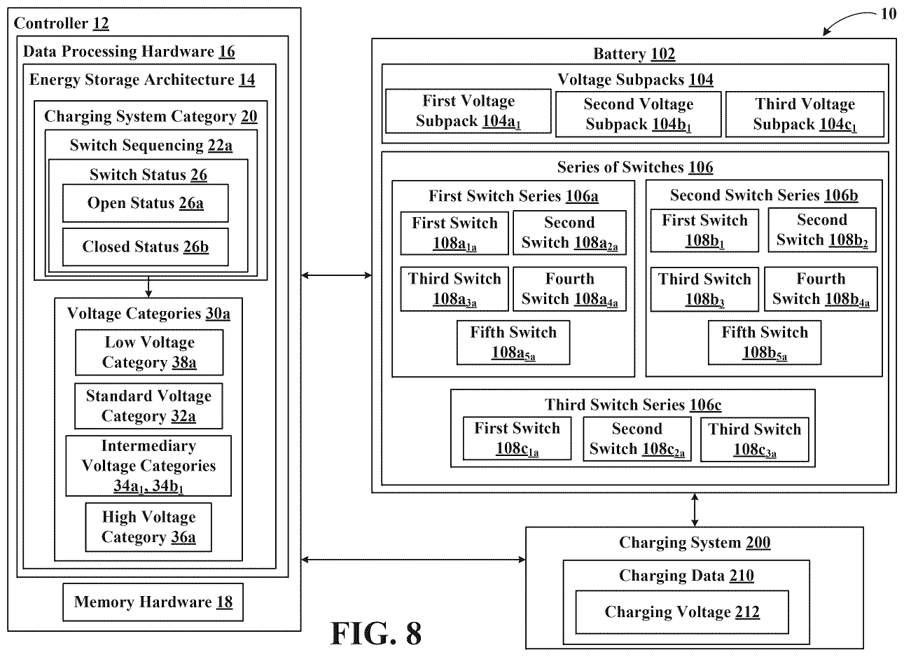

With particular reference to FIGS. 2 and 8-12, a rechargeable energy storage system 10a is provided. In view of the substantial similarity in structure and function of the components associated with the rechargeable energy storage system 10, like reference numerals are used hereinafter and in the drawings to identify like components while like reference numerals containing letter and/or number extensions are used to identify those components that have been modified.

A battery 102a of the rechargeable energy storage system 10a includes a first voltage subpack 104a₁, a second voltage subpack 104b₁, a third voltage subpack 104c₁, and a fourth voltage subpack 104d₁. Each of the voltage subpacks 104a₁-104d₁ have an equivalent voltage. For example, each voltage subpack 104a₁-104d₁ may have a voltage of approximately 375 volts (V). The voltage subpacks 104a₁-104d₁ may also have identical or otherwise equivalent amp hour (Ah) capacity.

The voltage subpacks 104, 104a₁-n₁ are selectively activated by opening and closing switches 108, 108a₁ₐ₋ₙ-108c₁ₐ₋ₙ of a series of switches 106, 106a₁-106c₁. An energy storage architecture 14 is configured to determine switch sequencing 22a based on the charging system category 20. For example, the switch sequencing 22a may include voltage categories 30a that are defined by a switch status 26 of each switch 108, 108a_{1-n,a}-108c_{1-n,a}. The switch status 26 may be a binary status, such that the respective switch 108, 108a_{1-n,a}-108c_{1-n,a} has either an open status 26a or a closed status 26b. The voltage categories 30a of the switch sequencing 22a correspond to a charging voltage 212 of a charging system 200a based on the identified charging system category 20.

For example, the voltage categories 30a may include a low voltage category 38a, a standard voltage category 32a, one or more intermediary voltage categories 34a₁, 34b₁, and a high voltage category 36a. The low voltage category 38a is different from the standard voltage category 32a in that the low voltage category 38a may generally correspond to a voltage of approximately 350 V. In comparison, the standard voltage category 32a may generally correspond to a voltage of approximately 700 V. The one or more intermediary voltage categories 34a₁, 34b₁ may include a first intermediary voltage category 34a₁ and a second intermediary voltage category 34b₁, described in more detail below. By way of example, not limitation, the one or more intermediary voltage categories 34a₁, 34b₁ may include a charging voltage 212 of approximately 1050 V. The high voltage category 36a may include a charging voltage 212 of approximately 1400 V.

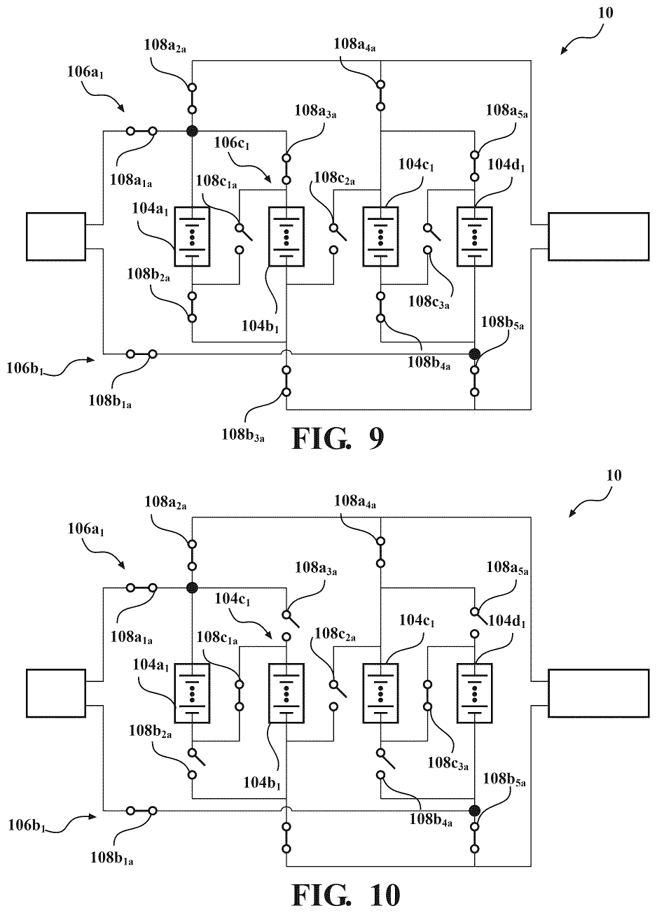

In the low voltage category 38a, all of the switches 108a₁ₐ-108a₅ₐ of the first switch series 106a₁ have the closed status 26b, all of the switches 108b₁ₐ-108b₅ₐ of the second switch series 106b₁ have the closed status 26b, and all of the switches 108c₁ₐ-108c₃ₐ of the third switch series 106c₁ have the open status 26a. For example, FIG. 9 illustrates each switch 108a₁ₐ-108a₅ₐ of the first switch series 106a₁ are in the closed status 26b. The second switch series 106b is also illustrated with each switch 108b₁ₐ-108b₅ₐ being in the closed status 26b. The third switch series 106c is illustrated with each of the first switch 108c₁ₐ, the second switch 108c₂ₐ, and the third switch 108c₃ₐ in the open status 26a. As a result, the fourth voltage subpack 104d₁ is activated, while the first voltage subpack 104a₁, the second voltage subpack 104b₁, and the third voltage subpack 104c₁ remain inactive in the low voltage category 38a.

In the standard voltage category 32a, two of the switches 108a₁ₐ-108a₅ₐ of the first switch series 106a₁ have the open status 26a, two of the switches 108b₁ₐ-108b₅ₐ of the second switch series 106b₁ have the open status 26a, and one of the switches 108c₁ₐ-108c₃ₐ of the third switch series 106c₁ have the open status 26a. For example, FIG. 10 illustrates a third switch 108a₃ and a fifth switch 108a₅ₐ of the first switch series 106a₁ are in the open status 26a, while the remainder of switches 108a₁ₐ, 108a₂ₐ, and 108a₄ₐ of the first switch series 106a₁ are in the closed status 26b. The second switch series 106b is illustrated with the first switch 108b₁ₐ and the fourth 108b₄ₐ being in the open status 26a, while the remainder of switches 108b₂ₐ, 108b₃ₐ, and 108b₅ₐ of the second switch series 106b₁ are in the closed status 26b. The third switch series 106c₁ is illustrated with the second switch 108c₂ₐ in the open status 26a, while the remainder of switches 108c₁ₐ, 108c₃ₐ of the third switch series 106c₁ are in the closed status 26b. As a result, the first voltage subpack 104a₁ and the second voltage subpack 104b₁ are activated, while the third voltage subpack 104c₁ and the fourth voltage subpack 104d₁ remain inactive in the standard voltage category 32a.

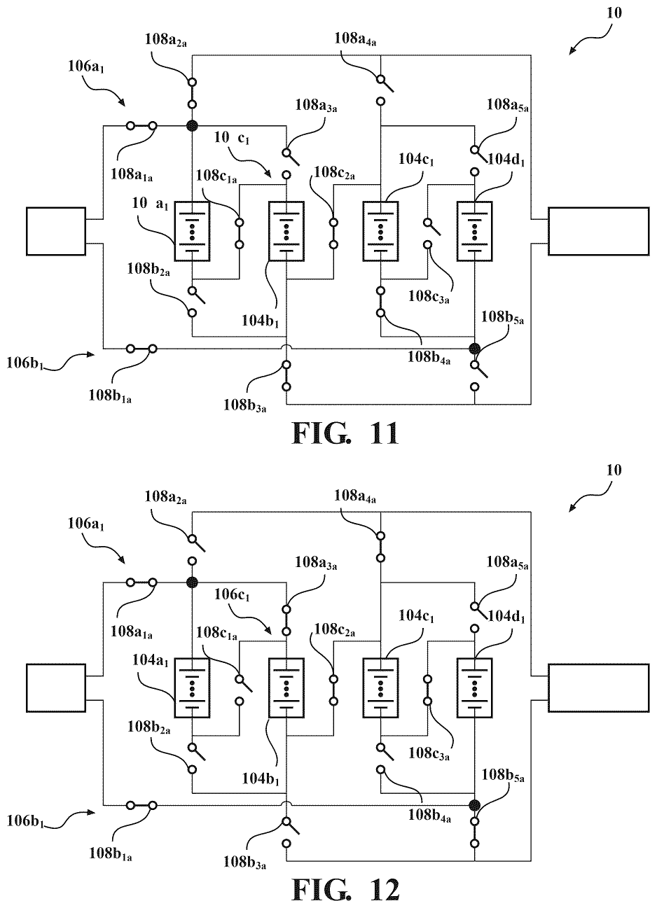

The intermediary voltage categories 34a₁, 34b₁ are illustrated in FIGS. 11 and 12. The first intermediary voltage category 34a₁, illustrated in FIG. 11, includes three of the switches 108a₁ₐ-108a₅ₐ of the first switch series 106a₁ having the open status 26a, two of the switches 108b₁ₐ-108b₅ₐ of the second switch series 106b₁ having the open status 26a, and one of the switches 108c₁ₐ-108c₃ₐ of the third switch series 106c₁ having the open status 26a. For example, the third switch 108a₃ₐ, the fourth switch 108a₄ₐ, and the fifth switch 108a₅ₐ of the first switch series 106a₁ are illustrated in the open status 26a, while the remainder of switches 108a₁ₐ-108a₂ₐ of the first switch series 106a₁ are in the closed status 26b. The second switch series 106b₁ is illustrated with the second switch 108b₂ₐ and the fifth switch 108b₅ₐ being in the open status 26a, while the remainder of the switches 108b₁ₐ, 108b₃ₐ, and 108b₅ₐ are in the closed status 26b. The third switch series 106c₁ is illustrated with the third switch 108c₃ₐ in the open status 26a in the closed status 26b, while the remainder of the switches 108c₁ₐ, 108c₂ₐ are in the closed status 26b. As a result, the first voltage subpack 104a₁, the second voltage subpack 104b₁, and the third voltage subpack 104c₁ are activated, while the fourth voltage subpack 104d₁ remains inactive in the first intermediary voltage category 34a₁.

In the second intermediary voltage category 34b₁, illustrated in FIG. 12, two of the switches 108a₁ₐ-108a₅ₐ of the first switch series 106a₁ have the open status 26a, three of the switches 108b₁ₐ-108b₅ₐ of the second switch series 106b₁ have the open status 26a, and one of the switches 108c₁ₐ-108c₃ₐ of the third switch series 106c₁ have the open status 26a. For example, the second switch 108a₂ₐ and the fifth switch 108a₅ₐ of the first switch series 106a₁ are illustrated in the open status 26a, while the remainder of switches 108a₁ₐ, 108a₃ₐ, 108a₄ₐ of the first switch series 106a₁ are in the closed status 26b. The second switch series 106b₁ is illustrated with the second switch 108b₂ₐ, the third switch 108b₃ₐ, and the fourth switch 108b₄ₐ in the open status 26a, while the remainder of switches 108b₁ₐ, 108b₅ₐ are in the closed status 26b. The third switch series 106c is illustrated with the first switch 108c₁ in the open status 26a, while the remainder of the switches 108c₁ₐ, 108c₂ₐ are in the closed status 26b. As a result, the second voltage subpack 104b₁, the third voltage subpack 104c₁, and the fourth voltage subpack 104d₁ are activated, while the first voltage subpack 104a₁ remains inactive in the second intermediary voltage category 34b₁.

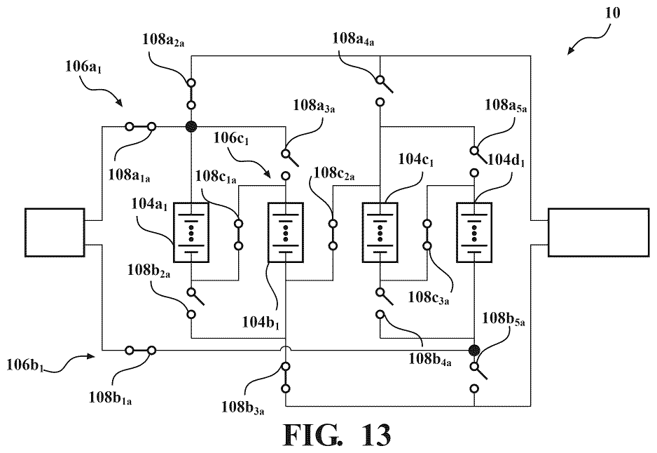

In the high voltage category 36a, illustrated in FIG. 13, three of the switches 108a₁ₐ-108a₅ₐ of the first switch series 106a₁ have the open status 26a, three of the switches 108b₁ₐ-108b₅ₐ of the second switch series 106b₁ have the open status 26a, and all of the switches 108c₁-108c₃ of the third switch series 106c₁ have the closed status 26b. For example, the third switch 108a₃ₐ, the fourth switch 108a₄ₐ, and the fifth switch 108a₅ₐ of the first switch series 106a₁ are illustrated in the open status 26a, while the remainder of switches 108a₁, 108a₂ of the first switch series 106a₁ are in the closed status 26b. The second switch series 106b₁ is illustrated with the second switch 108b₂ₐ, the fourth switch 108b₄ₐ, and the fifth switch 108b₅ₐ being in the open status 26a, while the remainder of switches 108b₁ₐ, 108b₃ₐ are in the closed status 26b. The third switch series 106c₁ is illustrated with all of the switches 108c₁ₐ-108c₃ₐ in the closed status 26b. As a result, all four voltage subpacks 104a₁-104d₁ are activated in the high voltage category 36a.

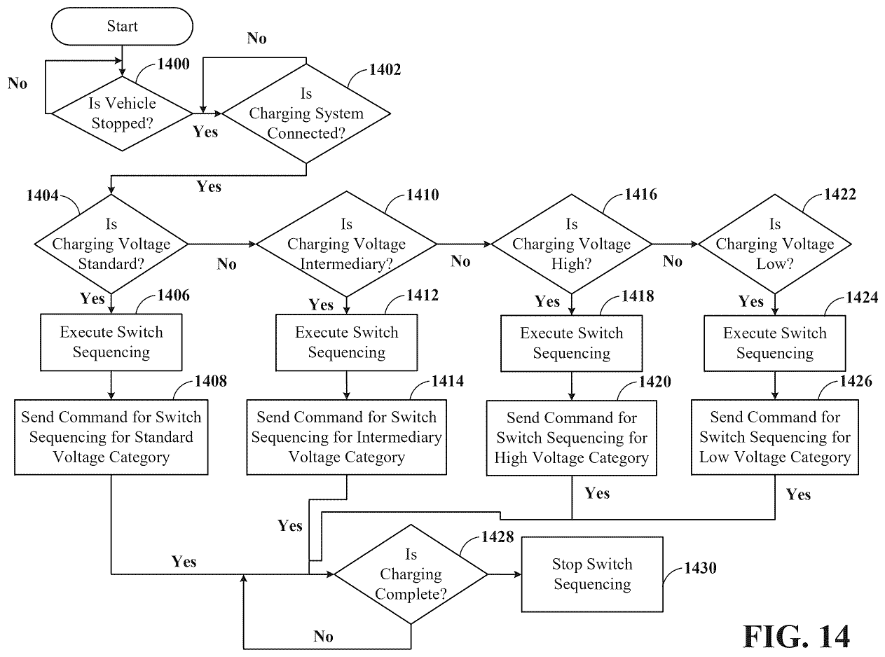

With reference now to FIG. 14, a flow diagram is illustrated demonstrating the operation of the rechargeable energy storage system 10. At 1400, the rechargeable energy storage system 10 determines whether the vehicle 100 is stopped. If not, the rechargeable energy storage system 10 continues to monitor until the vehicle 100 has stopped. If the vehicle 100 is stopped, the rechargeable energy storage system 10 determines, at 1402, whether the charging system 200 is connected. If not, the rechargeable energy storage system 10 continues to monitor until the charging system 200 is connected. If the charging system 200 is connected, then the rechargeable energy storage system 10 determines, at 1404, determines if the charging voltage 212 is a standard voltage category 32, 32a. If the charging voltage 212 is the standard voltage category 32, 32a, then the energy storage architecture 14 executes, at 1406, the switch sequencing 22 associated with the standard voltage category 32, 32a. The energy storage architecture 14 then sends, at 1408, the charging system 200 commands associated with the switch sequencing 22 for the standard voltage category 32, 32a.

If the charging voltage 212 is not the standard voltage category 32, 32a, then the rechargeable energy storage system 10 determines, at 1410, whether the charging voltage 212 is one of the intermediary voltage categories 34a-34b₁. If the charging voltage 212 is one of the intermediary voltage categories 34a-34b₁, then the energy storage architecture 14 executes, at 1412, the switch sequence 22 associated with one of the intermediary voltage categories 34a, 34b₁. The energy storage architecture 14 sends, at 1414, commands associated with the switch sequencing 22 for one of the intermediary voltage categories 34a, 34b₁.

If the charging voltage 212 is not one of the standard voltage category 32, 32a or the intermediary voltage categories 34a, 34b₁, then the rechargeable energy storage system 10 determines, at 1416, whether the charging voltage 212 is the high voltage category 36, 36a. If the charging voltage 212 is the high voltage category 36, 36a, then the energy storage architecture 14 executes, at 1418, the switch sequencing 22 associated with the high voltage category 36, 36a. The energy storage architecture 14 sends, at 1420, commands associated with the switch sequence 22 for the high voltage category 36, 36a.

If the charging voltage 212 is not one of the standard voltage category 32, 32a, the intermediary voltage categories 34a, 34b₁, or the high voltage category 36, 36a, then the rechargeable energy storage system 10 determines, at 1422, whether the charging voltage 212 is the low voltage category 38a. If the charging voltage 212 is the low voltage category 38a, then the energy storage architecture 14 executes, at 1424, the switch sequencing 22 associated with the low voltage category 38a. The energy storage architecture 14 sends, at 1426, commands associated with the switch sequence 22 for the low voltage category 38a.

After sending the commands associated with one of the voltage categories 32-38a, the rechargeable energy storage system 10 determines, at 1428, whether charging is complete. If charging is not complete, the rechargeable energy storage system 10 continues to monitor the charging progress. Once charging is complete, the rechargeable energy storage system 10 stops, at 1430, the switch sequence 22 to terminate charging.

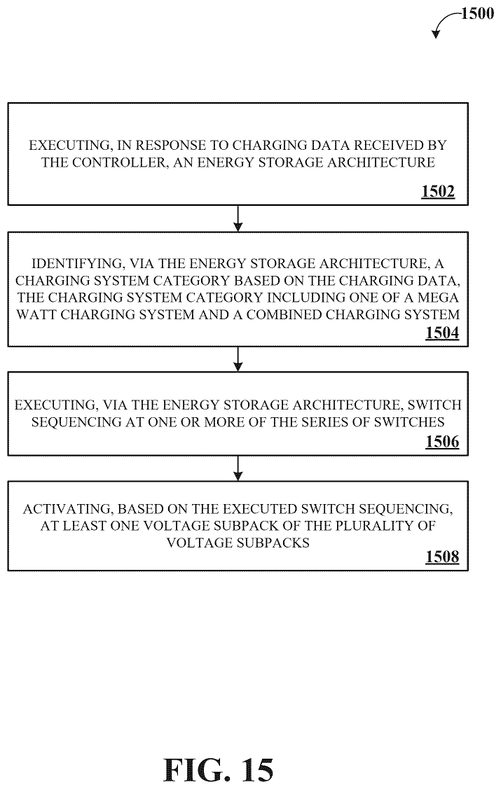

With reference to FIG. 15, an exemplary method 1500 of operating the rechargeable energy storage system 10 is illustrated. At 1502, an energy storage architecture 14 is executed in response to charge data received by a controller 12. The energy storage architecture 14 identifies, at 1504, a charging system category 20 based on the charge data 210. The charging system category 20 includes one of a mega watt charging system 202 and a combined charging system 204. At 1506, the energy storage architecture 14 executes switch sequencing 22 at one or more of a series of switches 106. The switch sequencing 22 includes opening at least three switches 108 from at least one of a first switch series 106a₁₋₄, 106a₁ₐ₋₅ₐ, the second switch series 106b₁₋₄, 106b₁ₐ₋₅ₐ, and the third switch series 106c₁₋₂, 106c₁ₐ₋₃ₐ and closing a remainder of switches 108 of the series of switches 106. At 1508, at least one voltage subpack 104 of the plurality of voltage subpacks 104 are activated based on the executed switch sequencing 22.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A rechargeable energy storage system for a vehicle, the rechargeable energy storage system comprising:
a plurality of voltage subpacks;
a series of switches operably coupled to the plurality of voltage subpacks; and
a controller including data processing hardware and memory hardware in communication with the data processing hardware, the memory hardware storing instructions that when executed on the data processing hardware cause the data processing hardware to perform operations comprising
executing, in response to charging data received by the controller, an energy storage architecture;
identifying, via the energy storage architecture, a charging system category based on the charging data, the charging system category including one of a mega watt charging system and a combined charging system;
executing, via the energy storage architecture, switch sequencing at one or more of the series of switches; and
activating, based on the executed switch sequencing, at least one voltage subpack of the plurality of voltage subpacks.

2. The rechargeable energy storage system of claim 1, wherein the plurality of voltage subpacks includes at least three voltage subpacks and the series of switches includes a first switch series, a second switch series, and a third switch series, the third switch series disposed between and operably coupled to the plurality of voltage subpacks.

3. The rechargeable energy storage system of claim 2, wherein the at least three voltage subpacks includes a first voltage subpack, a second voltage subpack, and a third voltage subpack, the second voltage subpack and the third voltage subpack having a voltage that is less than a voltage of the first voltage subpack.

4. The rechargeable energy storage system of claim 3, wherein executing the switch sequencing includes opening one switch of the first switch series, one switch of the second switch series, and one switch of the third switch series and closing a remainder of switches of the series of switches.

5. The rechargeable energy storage system of claim 3, wherein executing the switch sequencing includes opening two switches of the first switch series, one switch of the second switch series, and one switch of the third switch series and closing a remainder of switches of the series of switches.

6. The rechargeable energy storage system of claim 3, wherein executing the switch sequencing includes opening one switch of the first switch series, two switches of the second switch series, and two switches of the third switch series and closing a remainder of switches of the series of switches.

7. The rechargeable energy storage system of claim 3, wherein executing the switch sequencing includes opening two switches of the first switch series and two switches of the second switch series, closing all of the third switch series and closing a remainder of switches of the first switch series and a remainder of switches of the second switch series.

8. The rechargeable energy storage system of claim 2, wherein executing the switch sequencing includes opening three switches of the third switch series and closing a remainder of switches of each of the first switch series and the second switch series.

9. The rechargeable energy storage system of claim 2, wherein executing the switch sequencing includes opening at least two switches of the first switch series, at least two switches of the second switch series, and one switch of the third switch series and closing a remainder of switches of the series of switches.

10. The rechargeable energy storage system of claim 2, wherein executing the switch sequencing includes opening three switches of the first switch series and three switches of the second switch series, closing all of the third switch series and closing a remainder of switches of the first switch series and a remainder of switches of the second switch series.

11. A rechargeable energy storage system for a vehicle, the rechargeable energy storage system comprising:
a plurality of voltage subpacks including at least three voltage subpacks;
a series of switches operably coupled to the plurality of voltage subpacks, the series of switches includes a first switch series, a second switch series, and a third switch series, the third switch series disposed between and operably coupled to the plurality of voltage subpacks; and
a controller including data processing hardware and memory hardware in communication with the data processing hardware, the memory hardware storing instructions that when executed on the data processing hardware cause the data processing hardware to perform operations comprising
executing, in response to charging data received by the controller, an energy storage architecture;
identifying, via the energy storage architecture, a charging system category based on the charging data, the charging system category including one of a mega watt charging system and a combined charging system;
executing, via the energy storage architecture, switch sequencing at one or more of the series of switches, the switch sequencing including opening at least three switches from at least one of the first switch series, the second switch series, and the third switch series and closing a remainder of switches of the series of switches; and
activating, based on the executed switch sequencing, at least one voltage subpack of the plurality of voltage subpacks.

12. The rechargeable energy storage system of claim 11, wherein executing the switch sequencing includes opening one switch of the first switch series, one switch of the second switch series, and one switch of the third switch series and closing a remainder of switches of the series of switches.

13. The rechargeable energy storage system of claim 11, wherein executing the switch sequencing includes opening two switches of the first switch series, one switch of the second switch series, and one switch of the third switch series and closing a remainder of switches of the series of switches.

14. The rechargeable energy storage system of claim 11, wherein executing the switch sequencing includes opening one switch of the first switch series, two switches of the second switch series, and two switches of the third switch series and closing a remainder of switches of the series of switches.

15. The rechargeable energy storage system of claim 11, wherein executing the switch sequencing includes opening two switches of the first switch series and two switches of the second switch series, closing all of the third switch series and closing a remainder of switches of the first switch series and a remainder of switches of the second switch series.

16. The rechargeable energy storage system of claim 11, wherein executing the switch sequencing includes opening three switches of the third switch series and closing a remainder of switches of each of the first switch series and the second switch series.

17. The rechargeable energy storage system of claim 11, wherein executing the switch sequencing includes opening two switches of the first switch series, two switches of the second switch series, and one switch of the third switch series and closing a remainder of switches of the series of switches.

18. The rechargeable energy storage system of claim 11, wherein executing the switch sequencing includes opening three switches of the first switch series, two switches of the second switch series, and one switch of the third switch series and closing a remainder of switches of the series of switches.

19. The rechargeable energy storage system of claim 11, wherein executing the switch sequencing includes opening two switches of the first switch series, three switches of the second switch series, and one switch of the third switch series and closing a remainder of switches of the series of switches.

20. The rechargeable energy storage system of claim 11, wherein executing the switch sequencing includes opening three switches of the first switch series and three switches of the second switch series, closing all of the third switch series and closing a remainder of switches of the first switch series and a remainder of switches of the second switch series.
